(19) United States
(12) Patent Application Publication
(10) Pub. No.: US 2018/0114270 A1
(43) Pub. Date: Apr. 26, 2018

(54) OPERATIONAL DUE DILIGENCE METHOD AND SYSTEM

(71) Applicant: ENTREPRISE CASTLE HALL ALTERNATIVES INC., MONTREAL (CA)

(72) Inventors: CHRISTOPHER ADDY, CANDIAC (CA); ECHO BELL, GLOUSCESTER (CA)

(21) Appl. No.: 15/787,909

(22) Filed: Oct. 19, 2017

Related U.S. Application Data
(60) Provisional application No. 62/413,390, filed on Oct. 26, 2016.

(51) Int. Cl. G06Q 40/06; G06Q 30/02

(52) U.S. Cl. CPC G06Q 40/06; G06Q 30/0203

(57) ABSTRACT

A method and system for providing an operational due diligence report for an investment. The method includes the steps of: identifying an asset class for the investment; issuing a due diligence questionnaire corresponding to the asset class; receiving a response thereto; verifying data and service providers information from the response; triggering data and verification flags, each flag having a binary decision-making condition based on the data and service providers information, if the condition is met, the flag is triggered; generating standardized text relating to each of the triggered data and verification flags, the standard text describing the rationale behind an associated triggered flag and the importance of the issue related to the triggered flag from an operational data perspective; generating a first version of the operational due diligence report; and providing the first version of the operational due diligence report.

### CROSS REFERENCE TO RELATED APPLICATION

This application claims benefit, under 35 U.S.C. § 119(e), of U.S. provisional application Ser. No. 62/413,390, filed on Oct. 26, 2016, which is incorporated herein in its entirety by reference.

### TECHNICAL FIELD

The present disclosure relates to an operational due diligence method and system. More specifically, the present disclosure relates to an operational due diligence method and system for evaluating whether asset managers meet operational best practice.

### BACKGROUND

Historically, operational due diligence has been a manual process that requires highly experienced individuals with specialized skillsets to complete. A typical operational due diligence review memorialize facts and opinions at a particular point in time in one or more, disparate, word-processed reports.

The diligence approach may include:

requesting information from an asset manager;

reviewing the information provided;

interviewing the asset management firm;

producing a final report.

This process is time intensive and often produces reports that lack consistency, comprehensiveness, scalability and relevance over time.

Therefore, there is a need for an operational due diligence method and system that overcome these limitations.

### BRIEF DESCRIPTION OF THE FIGURES

Embodiments of the disclosure will be described by way of examples only with reference to the accompanying drawings, in which:

FIG. 1 is a schematic view of computing devices connected to an operational due diligence system through a network;

FIG. 2 is a schematic representation of the operational due diligence system in accordance with an illustrative embodiment of the present disclosure;

FIG. 3 is a flow diagram depicting the operational due diligence verification process in accordance with the illustrative embodiment of the present disclosure;

FIG. 4 is a flow diagram depicting the operational due diligence review process in accordance with the illustrative embodiment of the present disclosure;

FIGS. 5A to 5D are examples of data request forms for a manager (FIGS. 5A to 5C) and for a fund (FIGS. 5D and 5E);

FIGS. 6A and 6B are examples of document request forms for a manager (FIG. 6A) and for a fund (FIG. 6B);

FIGS. 7A to 7C are examples of data and verification related flags with associated flag categories;

FIGS. 8A to 8C are examples of automated flag trigger decision trees;

FIGS. 9A to 9G are examples of diligence related flags with associated flag categories; and

FIGS. 10A to 10E are examples of client interface menus and displays.

Similar references used in different Figures denote similar components.

### DETAILED DESCRIPTION

Generally stated, the non-limitative illustrative embodiments of the present disclosure provide an operational due diligence method and system that use an integrated, systematic and comprehensive set of processes and technologies that facilitate comprehensiveness, scalability and relevance over time. The disclosed method and system helps clients, (i.e. investors, institutions, fund of funds, advisors, endowments and family offices) evaluate whether asset managers of hedge funds, private equity and long only portfolios meet operational best practice.

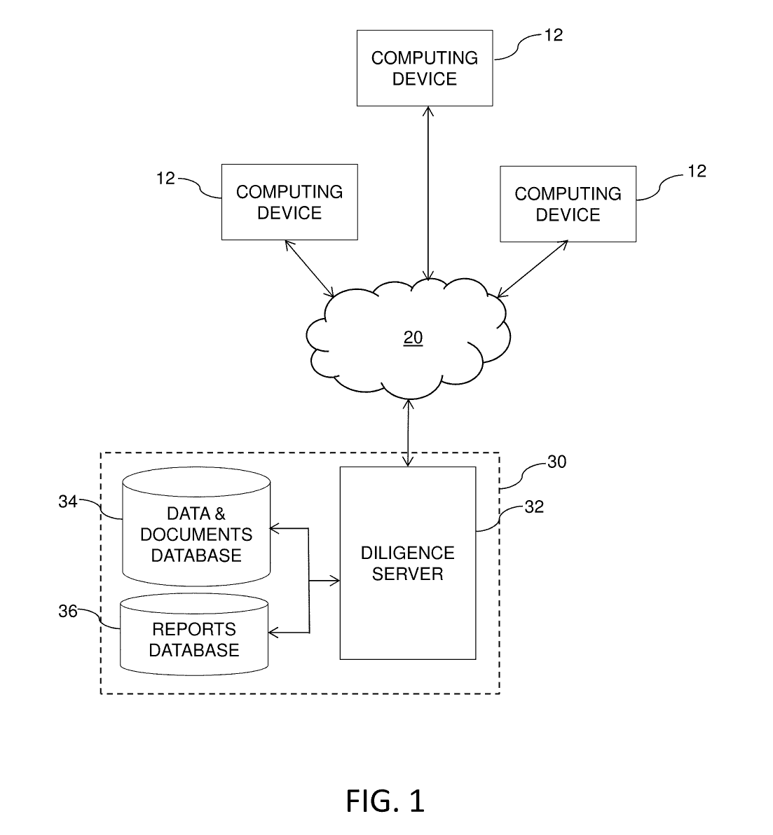

Referring to FIG. 1, clients using various computing devices 12 such as, for example, a personal computer, a laptop computer, a smart phone, tablet PC or any other such computing device, on which runs a user interface in the form of a communication software such as, for example, a web browser, may access the operational due diligence system 30 through a communication portal (e.g. web portal) on the diligence server 32 via a network 20 such as, for example, Ethernet (broadband, high-speed), wireless WiFi, cable Internet, satellite connection, 3G, 4G, LTE or other cellular/mobile network, etc., or a combination thereof.

Further to the diligence server 32, the operational due diligence system 30 includes a data and documents database 34 and a reports database 36, all of which will be detailed further below. It is to be understood that although throughout the disclosure reference is made to separate server 32 and databases 34 and 36, these may be implemented on one or more physical device and/or may be combined. It is to be further understood that the data and documents 34 and reports 36 databases may equally be implemented by a data structure within a computer memory, such as the memory of diligence server 32.

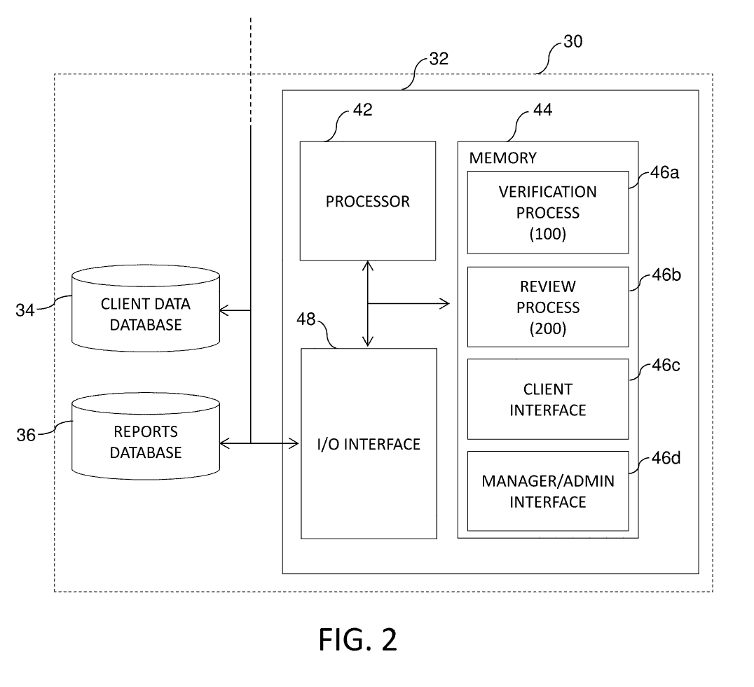

Referring now to FIG. 2, the diligence server 32 includes a processor 42 with an associated memory 44 having stored therein processor executable instructions 46a, 46b, 46c and 46d for configuring the processor 42 to perform, respectively, the verification process 100, the review process 200, the client interface and the manager interface. The diligence server 32 further includes an input/output (I/O) interface 48, which may include a web server, for communication with the client data database 34, the reports database 36, the network 20 and the computing devices 12.

It is to be understood that in alternative embodiments the client interface 46c and/or the manager/admin interface 46d may be implemented or executed on a computing device 12 or a third party device (i.e. server, website, etc.).

### Operational Due Diligence Verification

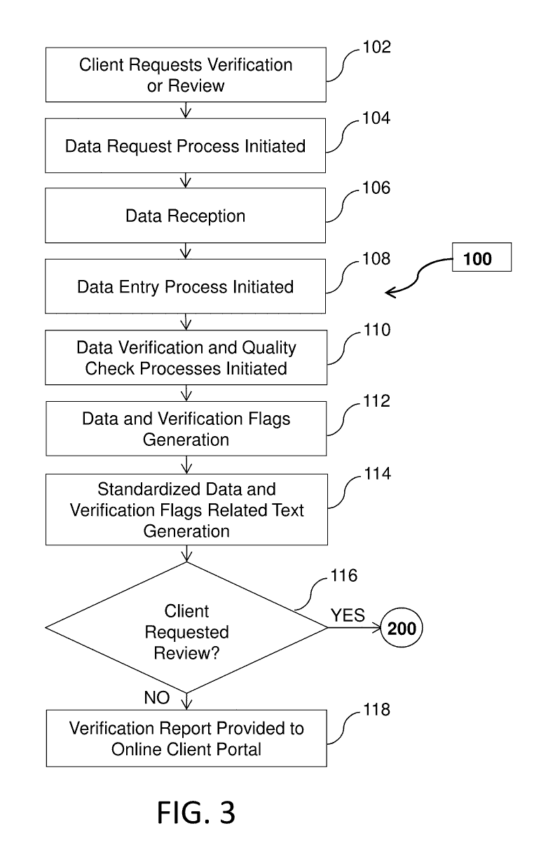

Referring now to FIG. 3, there is shown a flow diagram of the operational due diligence verification process 100. Steps of the process 100 are indicated by blocks 102 to 118.

The process 100 starts at block 102 where a client requests an operational due diligence verification or review.

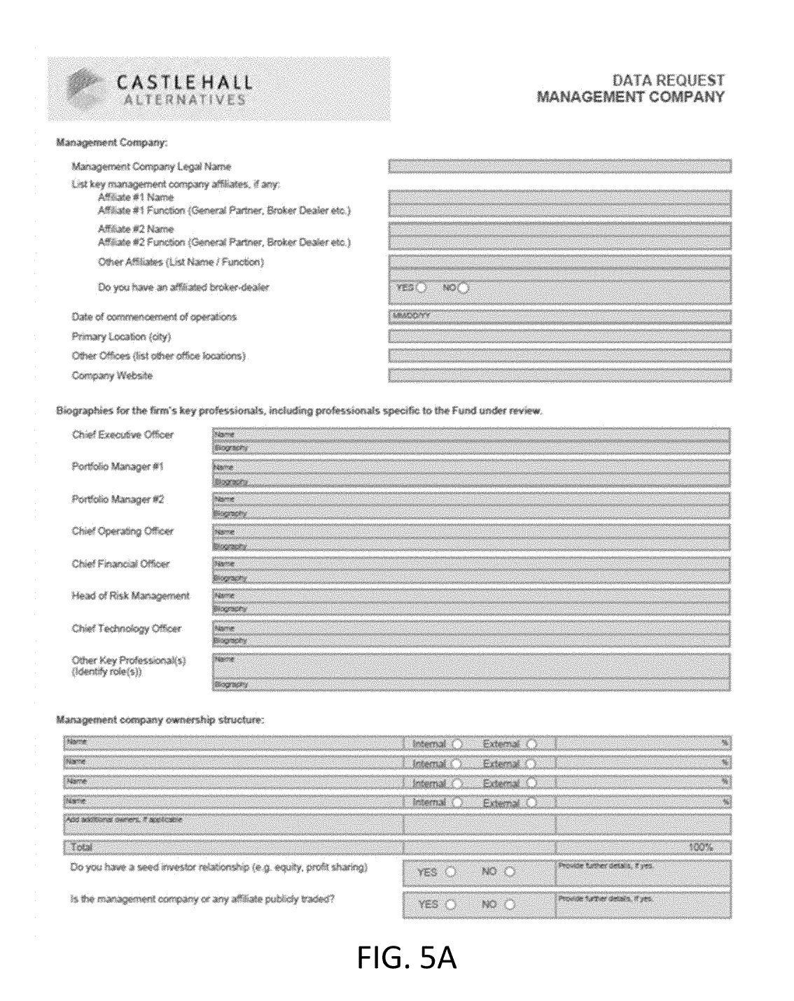

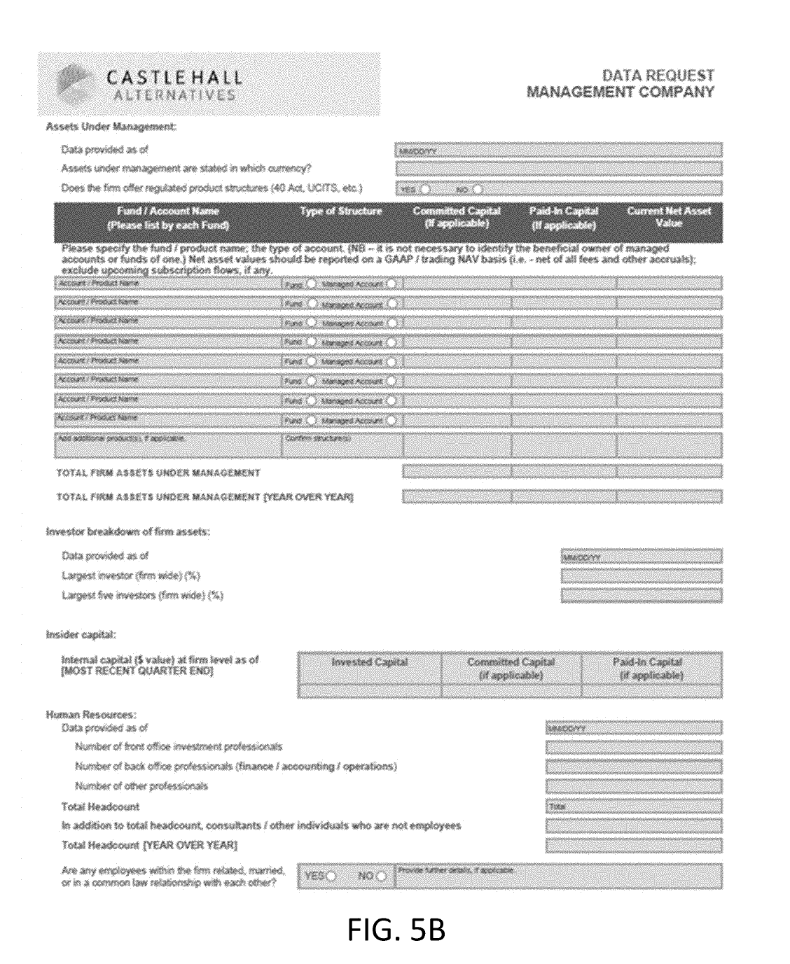

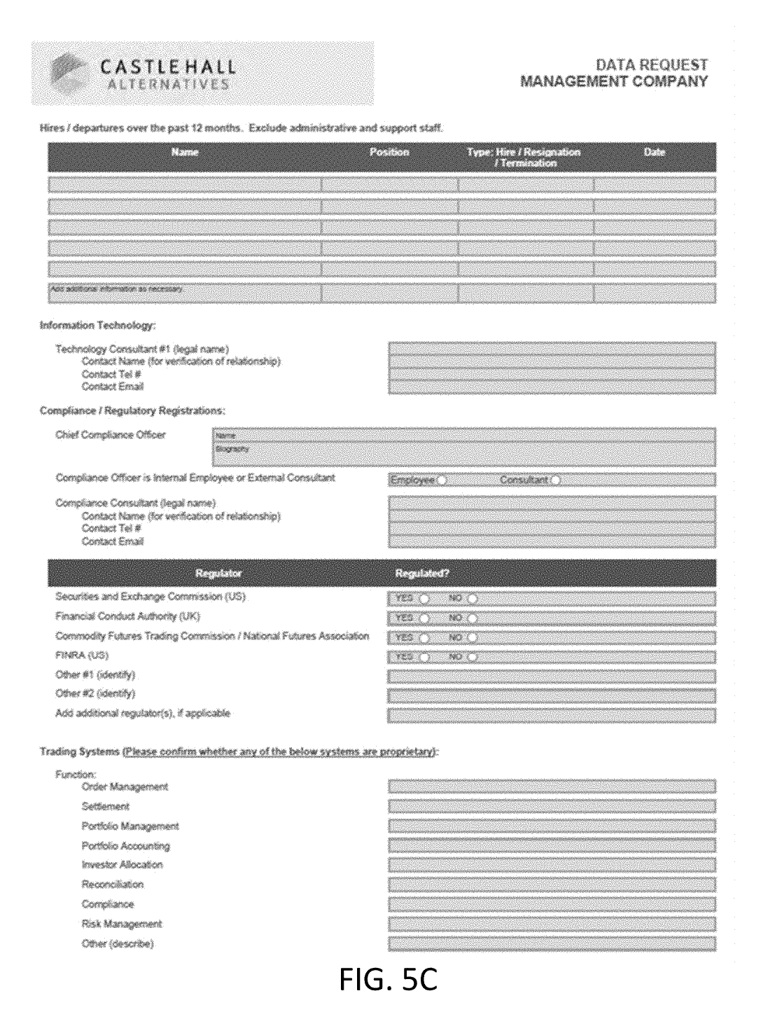

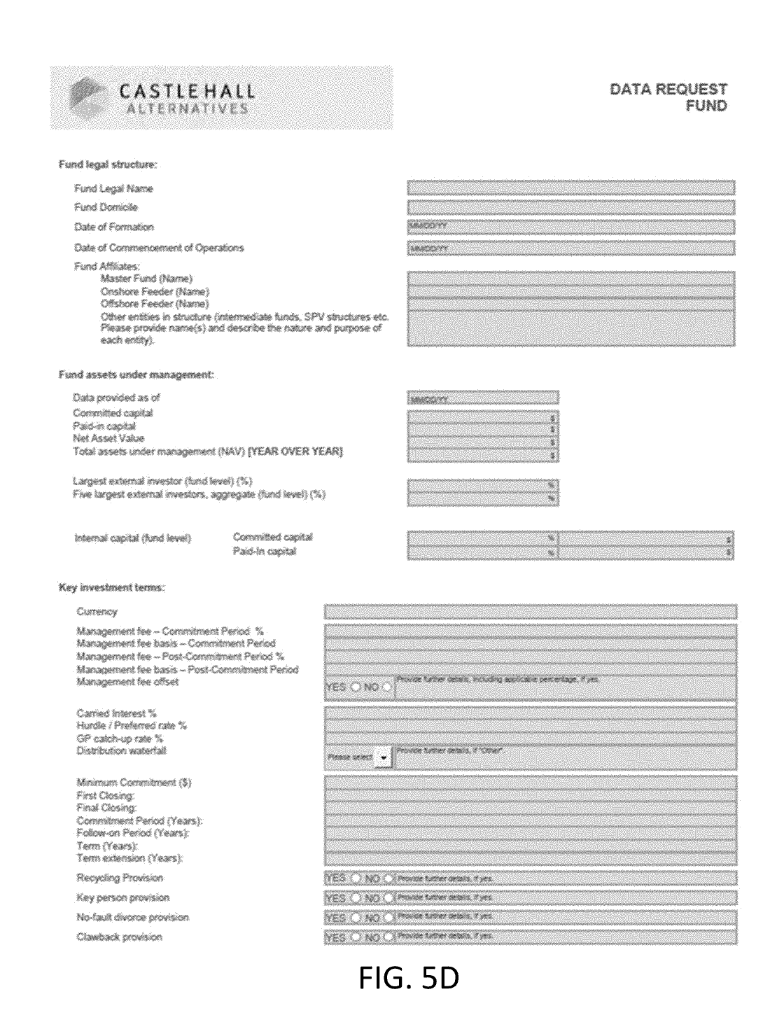

At block 104, the logging of the verification or review request into the operational due diligence system 30 triggers the commencement of the data gathering process. The asset class of the investment being the subject of the verification or review is identified, which then triggers the issuance of a standardized due diligence questionnaire (appropriate to the asset class covered), which is provided to the manager of the asset being the object of the due diligence as an attachment to, or in a link to an online form in, an email. In the case of an online form, the questionnaire is accessed via the manager/admin interface 46d running on the diligence server 32. It is to be understood that the online form may also be executed on a third party server. FIGS. 5A and 5B show examples of data requests for manager (FIGS. 5A to 5C) and fund (FIGS. 5D and 5E). It is to be understood that the forms may vary depending whether the manager operates a closed-ended, private equity or an open-ended product structure.

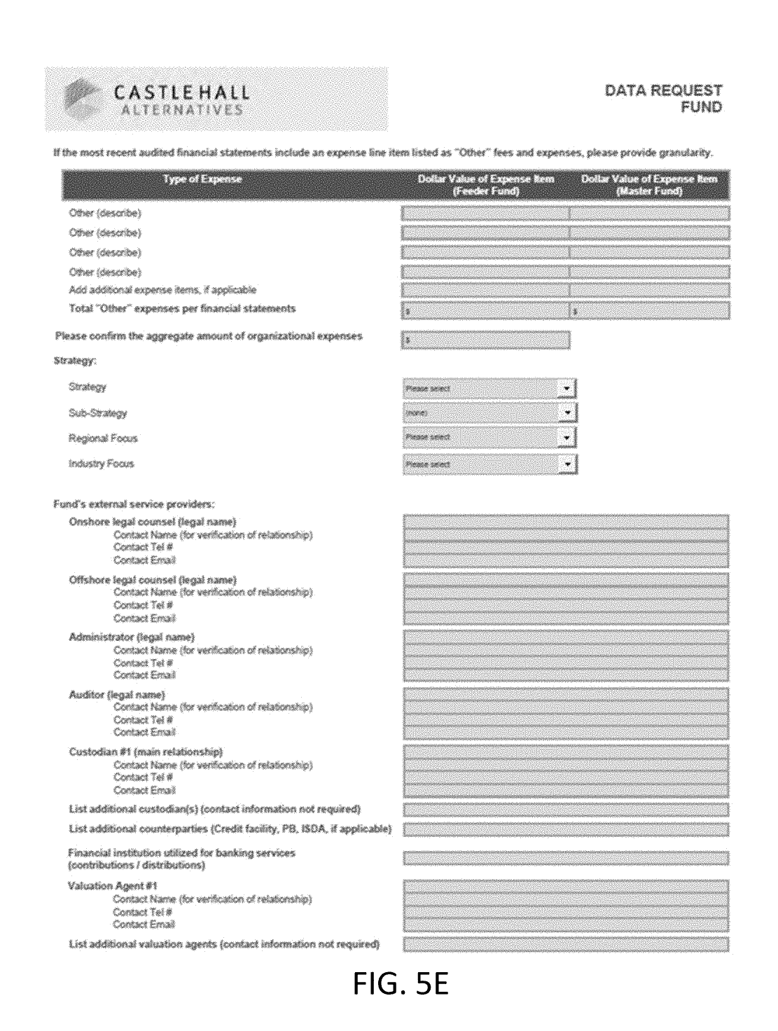

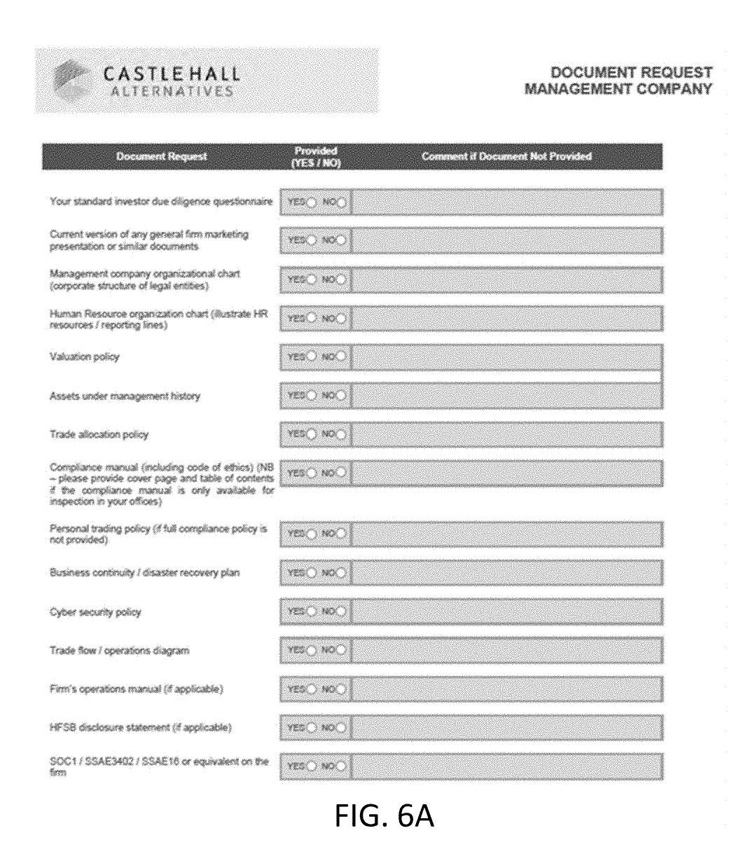

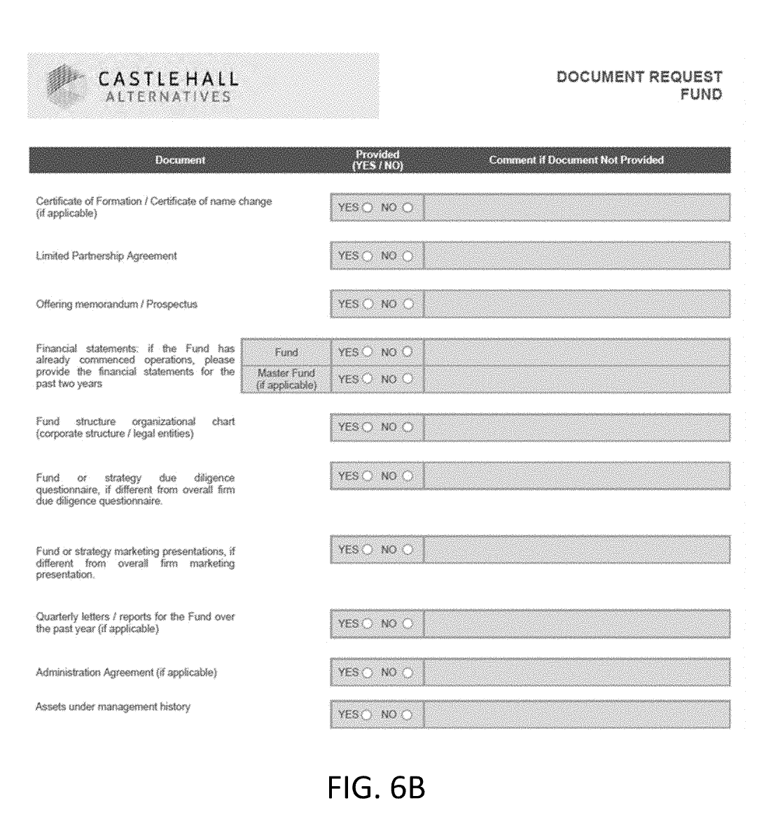

Included in the email or online form is a request for manager and fund related documents. FIGS. 6A and 6B show examples of document requests for manager (FIG. 6A) and fund (FIG. 6B). It is to be understood that the forms may vary depending whether the manager operates a closed-ended, private equity or an open-ended product structure.

The operational due diligence system 30 tracks the status of data requests. In the illustrative embodiment, managers are granted two weeks to respond before the operational due diligence system 30 seeks from the manager clarification on the delivery status of the data and documents requested. Optionally, the operational due diligence system 30 may prompt an analyst to follow up with the manager. It is to be understood that the delay accorded to managers for responding may be configurable.

Once the data has been received, at block 106, data entry is initiated at block 108 for any data not provided via an online form. All data and documents are stored into the data and documents database 34.

Then, at block 110, the verification of key data points and service providers is initiated.

The operational due diligence system 30 tracks the status of verification activities and verification requests of service providers. In the illustrative embodiment, service providers are granted one week to respond before the operational due diligence system 30 seeks from the service providers clarification on the delivery status of the data and documents requested. Optionally, the operational due diligence system 30 may prompt an analyst to follow up with the service providers. It is to be understood that the delay accorded to service providers for responding may be configurable.

Completed and incomplete verifications are noted and the preliminary data and verification information is sent to the quality check process. Any deficiencies are noted and sent to an analyst for follow up if needed.

If no further follow up is required and the data and verification information is cleared to proceed, then process 100 proceeds to block 112 where data and verification related flags are triggered.

The operational due diligence system 30 is provided with a plurality of potential data and verification flags. When data and verification procedures receive sign-off, and data points that cross their respective conditions will automatically cause the associated flags to be triggered. Each flag has a binary decision-making condition. If the condition is met, the flag is triggered. If the condition is not met, the flag is not triggered.

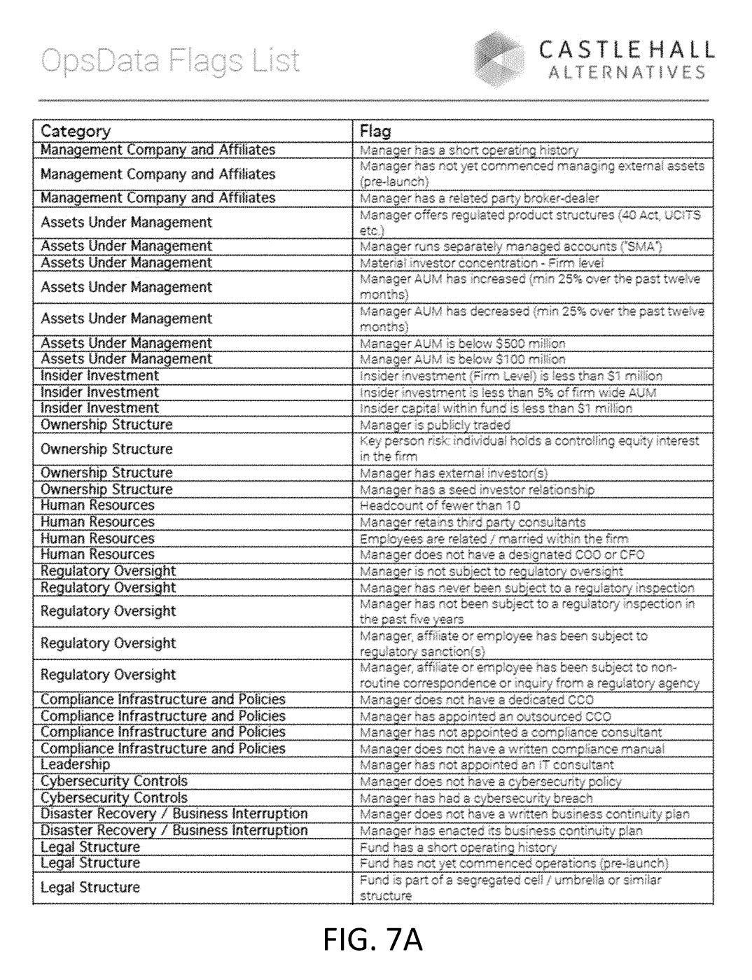

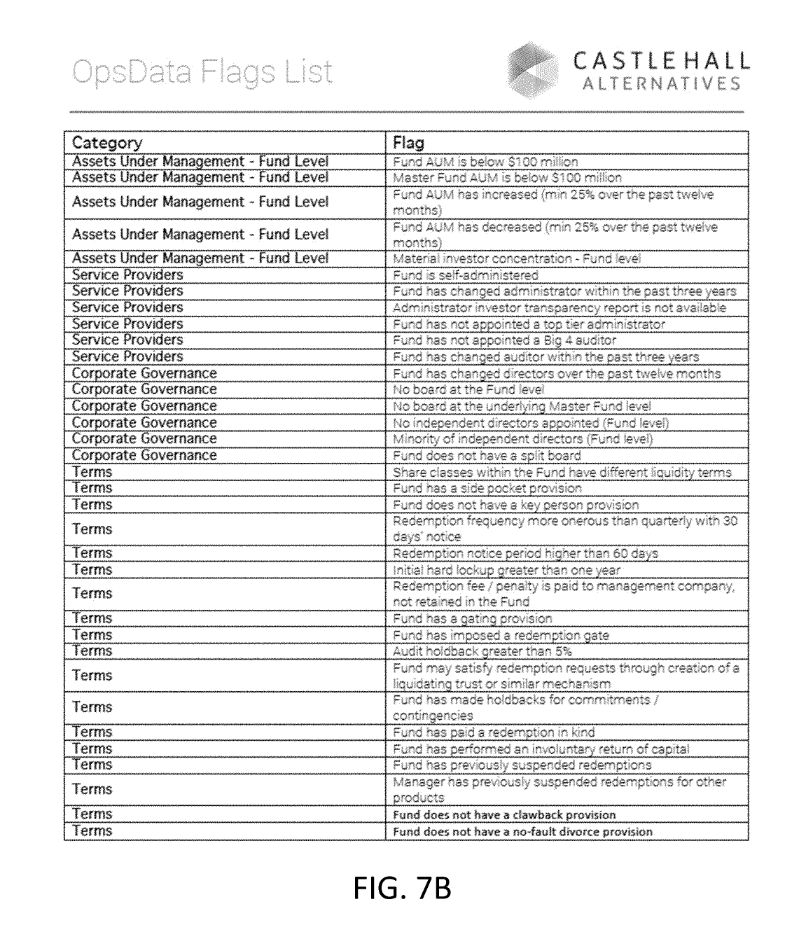

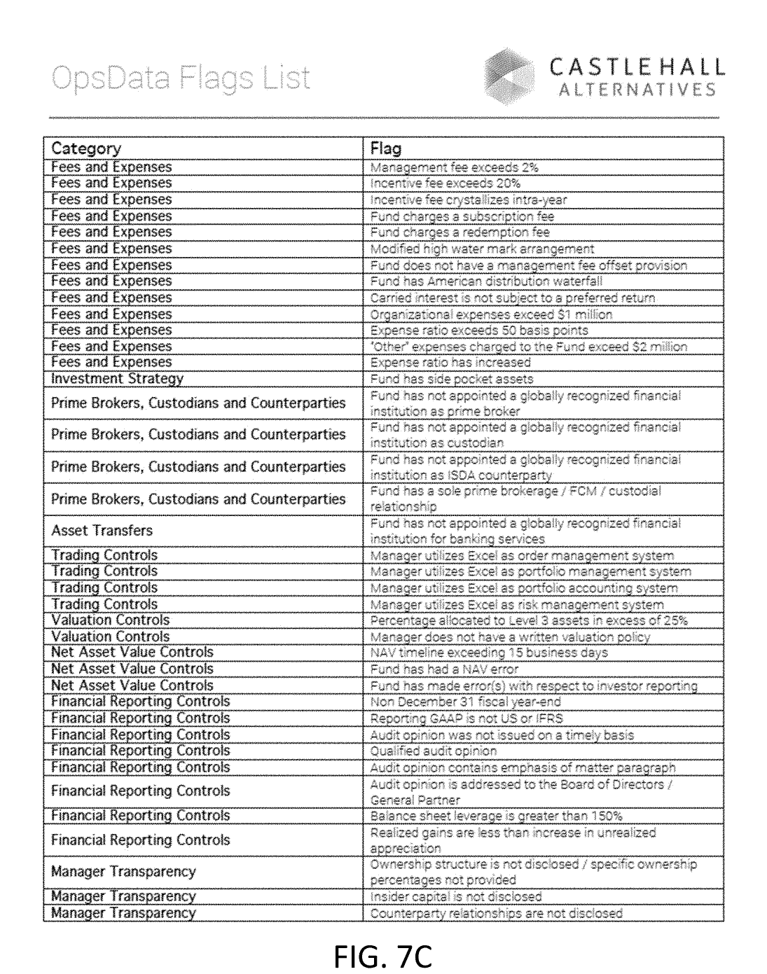

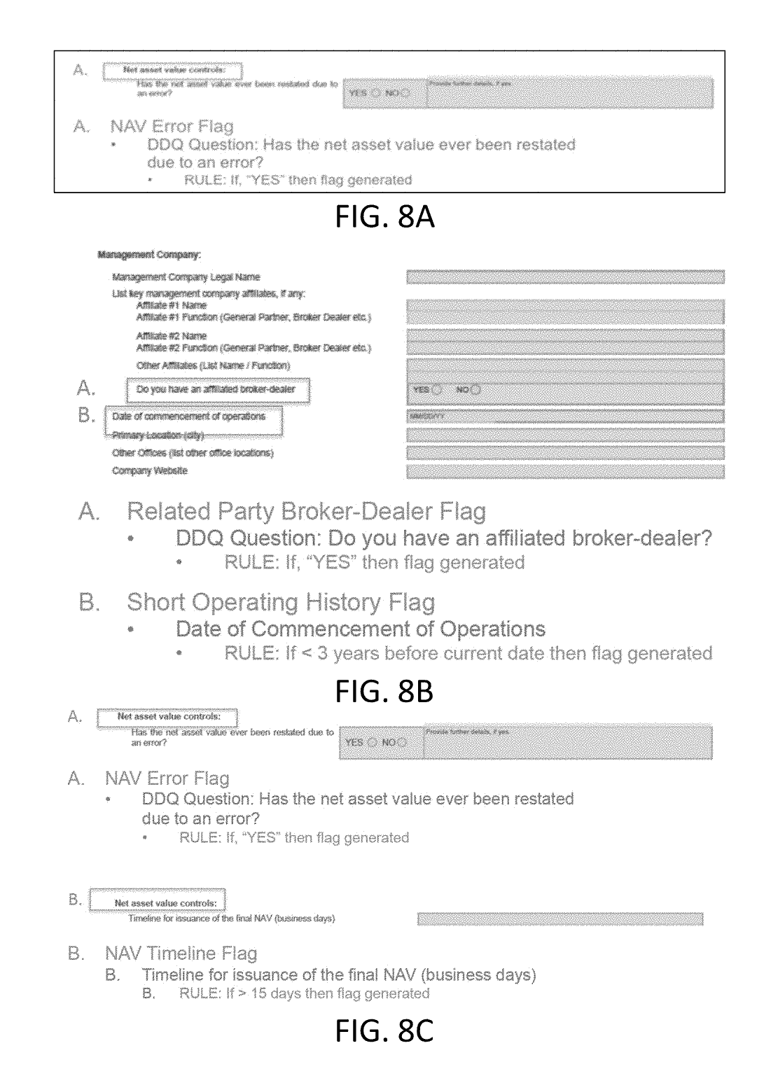

Referring to FIGS. 7A to 7C, there are shown examples of potential data and verification related flags with associated flag categories, while FIGS. 8A to 8C, there are shown examples of automated flag trigger decision trees.

Then, at block 114, standardized text relating to the triggered data and verification flags is generated. Each data flag is pre-programmed with standard text describing the rationale behind the flag and the importance of the flagged issue from an operational data perspective.

For example, the standardized text relating to the “Manager retains third party consultants” data flag:
A manager may increase its investment or operational resources through use of third party consultants in addition to full time employees. Diligence should consider the nature of consulting relationship, and consider factors such as 1) the duration of the consultant relationship (permanent or temporary); 2) whether consultants act exclusively for the manager or have other clients; if a consultant has other clients, potential conflicts of interest should be identified; 3) whether consultants are subject to binding contracts which include provisions around confidentiality and operational considerations such as adherence to Manager cyber security policies.

In another example, the standardized text relating to the “Manager does not have a cybersecurity policy” data flag:
Given recent attention to cyber security and risks of cyber attacks in the asset management industry, we consider it to be best practice for an asset manager to prepare an adequately detailed cyber security policy document. The cyber security policy should address key cyber security issues such as who is responsible for information security within the firm, polices around software and hardware access controls, and procedures to be adopted in the event of a suspected or actual data security breach.

In a further example, the standardized text relating to the “Assets Under Management Verification (Quarter End)” verification flag:
[AdministratorName] reported that the Fund [and Master Fund]'s net assets as of [insert date of quarter end] were [$XXX.X million] and [$XXX.X million], respectively, which is consistent with the information presented by the Manager. As such, the operator (such as Castle Hall) is confident in the existence of assets and liabilities reported by the Manager.

In another example, the standardized text relating to the “Administration agreement verification” verification flag:
The operator (such as Castle Hall) obtained a copy of the administration agreement dated [MONTH DAY, YEAR].

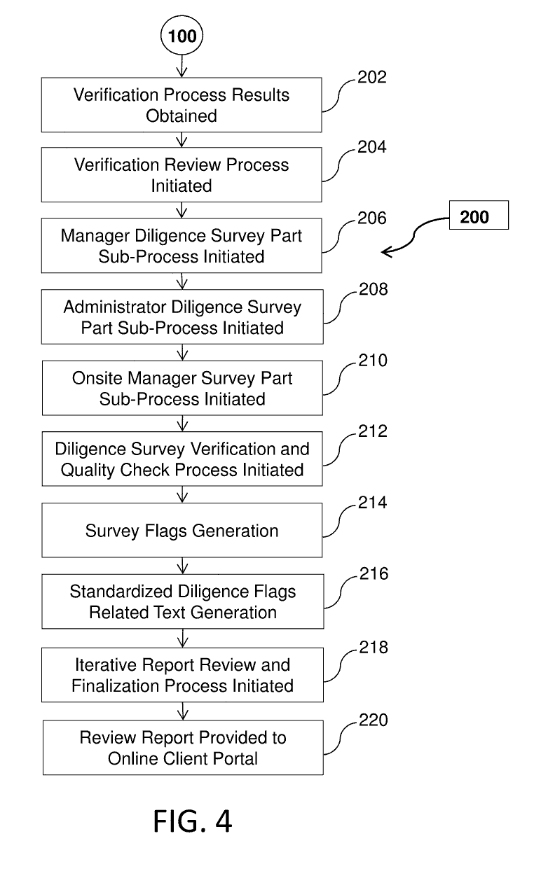

At block 116, if the client has requested an operational due diligence review at block 102, the process 100 proceeds to the operational due diligence review process 200 (see FIG. 4), if not, it proceeds to block 118 where a verification report is stored into the reports database 36 and provided to the online client portal via the client interface 46c. The verification report includes, amongst other information, the standardized text relating to the triggered data and verification flags.

### Operational Due Diligence Review

Referring now to FIG. 4, there is shown a flow diagram of the operational due diligence review process 200. Steps of process 200 are indicated by blocks 202 to 218.

The process 200 starts at block 202 where the verification process results from block 116 of process 100 (see FIG. 3) are obtained after which, at block 204, the verification review process is initiated.

The review process is in the form of a guided-survey with standard questions across a wide array of risk categories. The specific set of survey questions depends upon the asset class in question. The survey is in three parts; the preliminary manager diligence part, the administrator diligence survey part and the onsite manager diligence survey part, each driven by an associated sub-process:
the preliminary manager diligence survey part sub-process initiated at block 206;
the administrator diligence survey part (if applicable) sub-process initiated at block 208; and
the onsite manager diligence survey part sub-process initiated at block 210.

As previously, the survey may be provided as an attachment to, or in a link to an online form in, an email. In the case of an online form, the survey is accessed via the manager/admin interface 46d running on the diligence server 32. It is to be understood that the online form may also be executed on a third party server. Furthermore, the onsite manager diligence survey sub-process may involve the sending of an analyst onsite in order to verify certain items and that such analyst may use a tablet PC or other computing device to complete the survey. All data is stored into the data and documents database 34.

Then, at block 212, the verification of the diligence survey response is initiated, at which time additional clarifying questions investigating further or deeper into a specific topic may be generated.

The operational due diligence system 30 tracks the status of survey activities. In the illustrative embodiment, the service manager and administrator are granted one week to respond before the operational due diligence system 30 seeks from the manager and/or administrator clarification on the delivery status of the survey. Optionally, the operational due diligence system 30 may prompt an analyst to follow up with the manager and/or administrator. It is to be understood that the delay accorded to the manager and/or administrator for responding may be configurable.

Completed and incomplete verifications are noted and the preliminary survey information is sent to the quality check process. Any deficiencies are noted and sent to an analyst for follow up if needed.

If no further follow up is required and the survey information is cleared to proceed, then process 200 proceeds to block 214 where diligence related flags are triggered.

At block 214, diligence related flags are triggered. The operational due diligence system 30 is provided with a plurality of potential diligence flags related to the preliminary manager diligence, the administrator diligence and the onsite manager diligence survey parts of the survey. As for the data flags, each diligence flag has a binary decision-making condition. If the condition is met, the flag is triggered. If the condition is not met, the flag is not triggered.

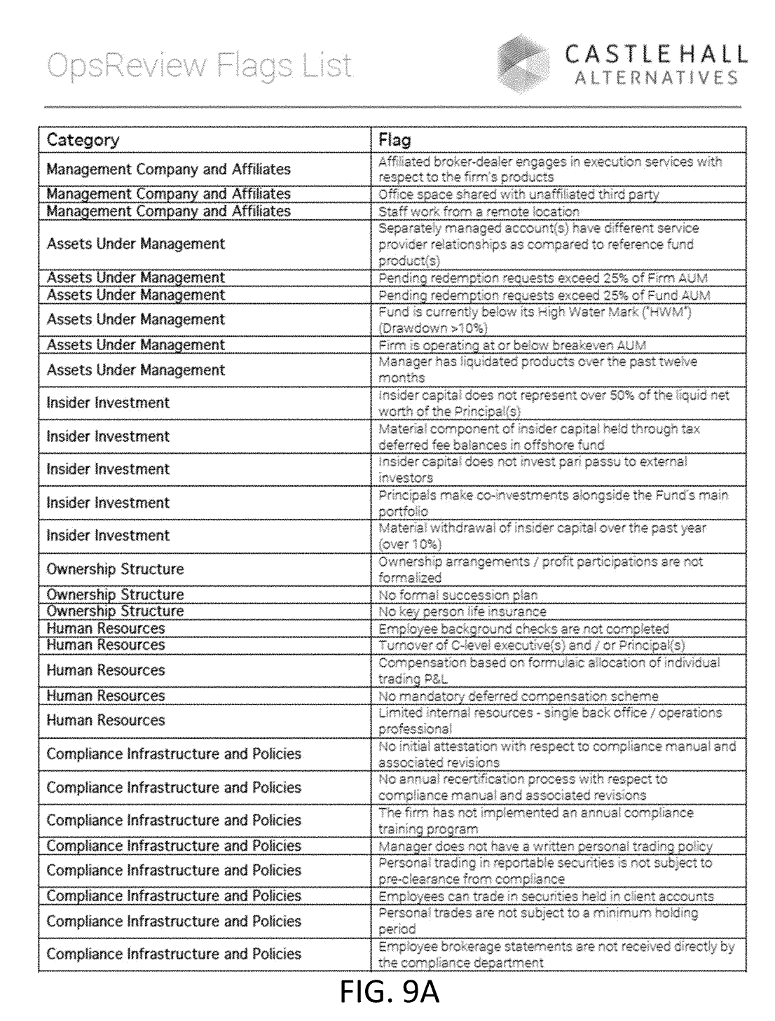

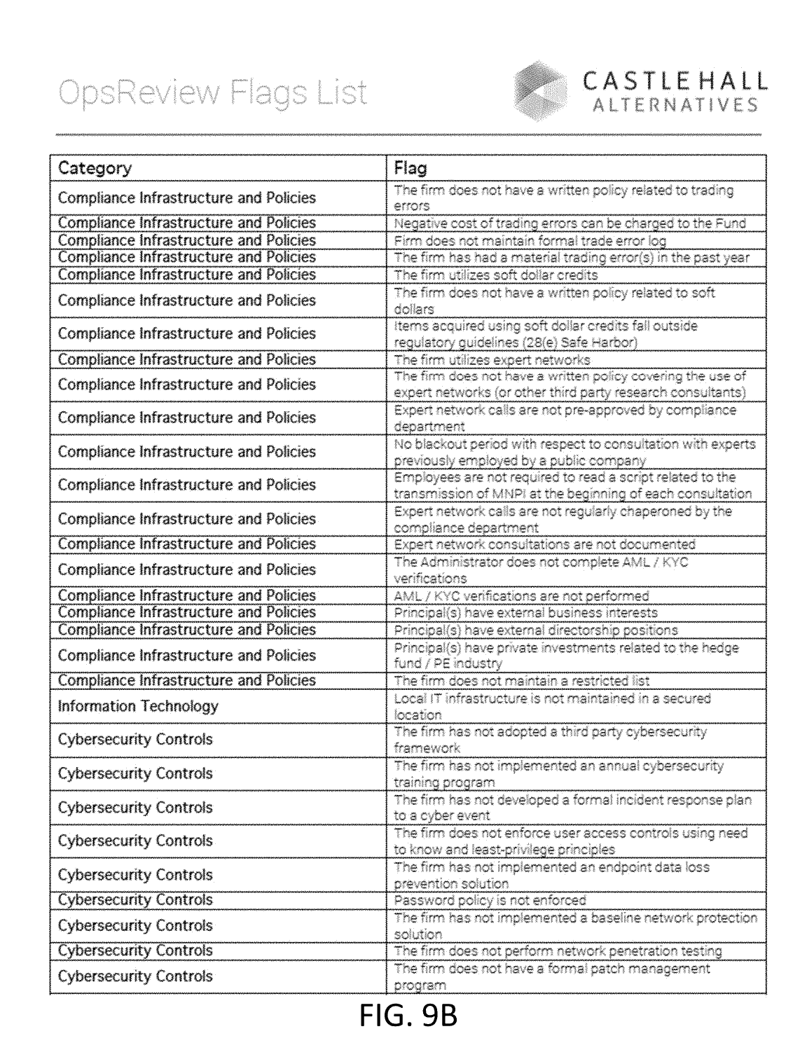

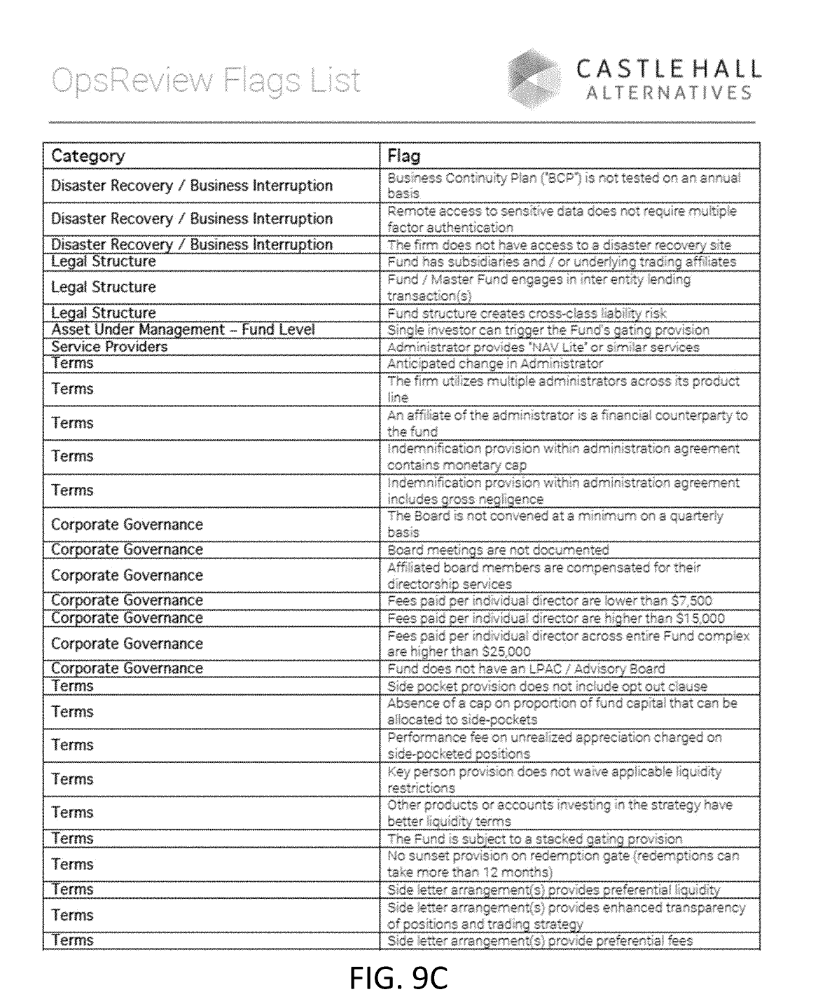

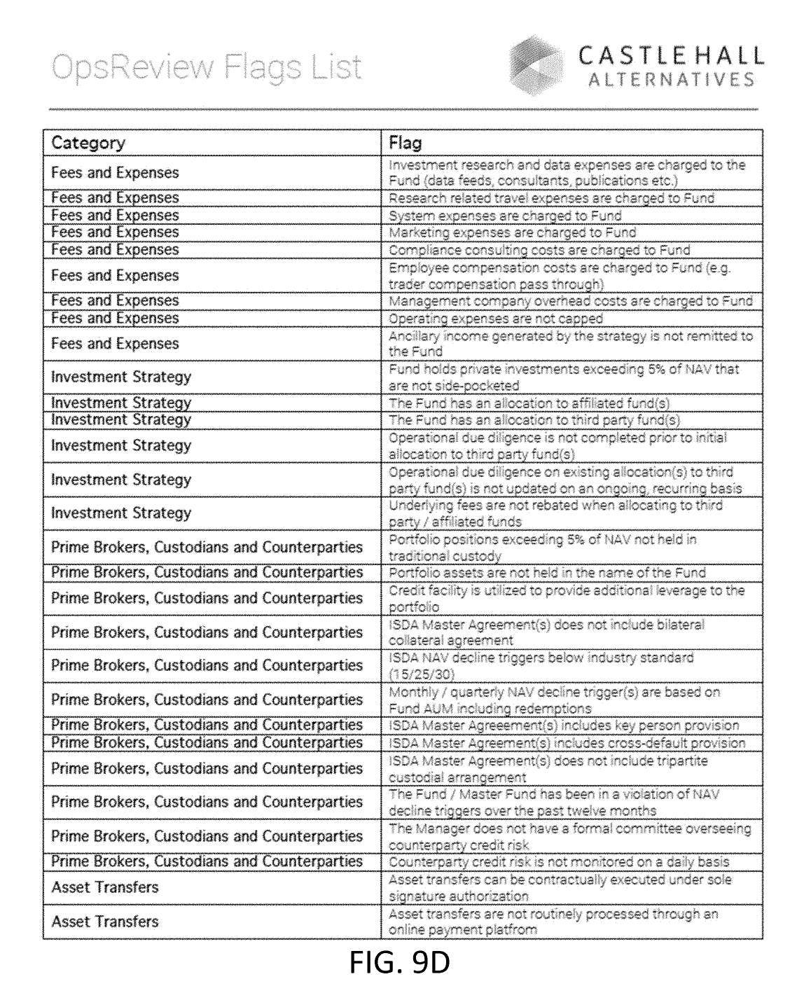

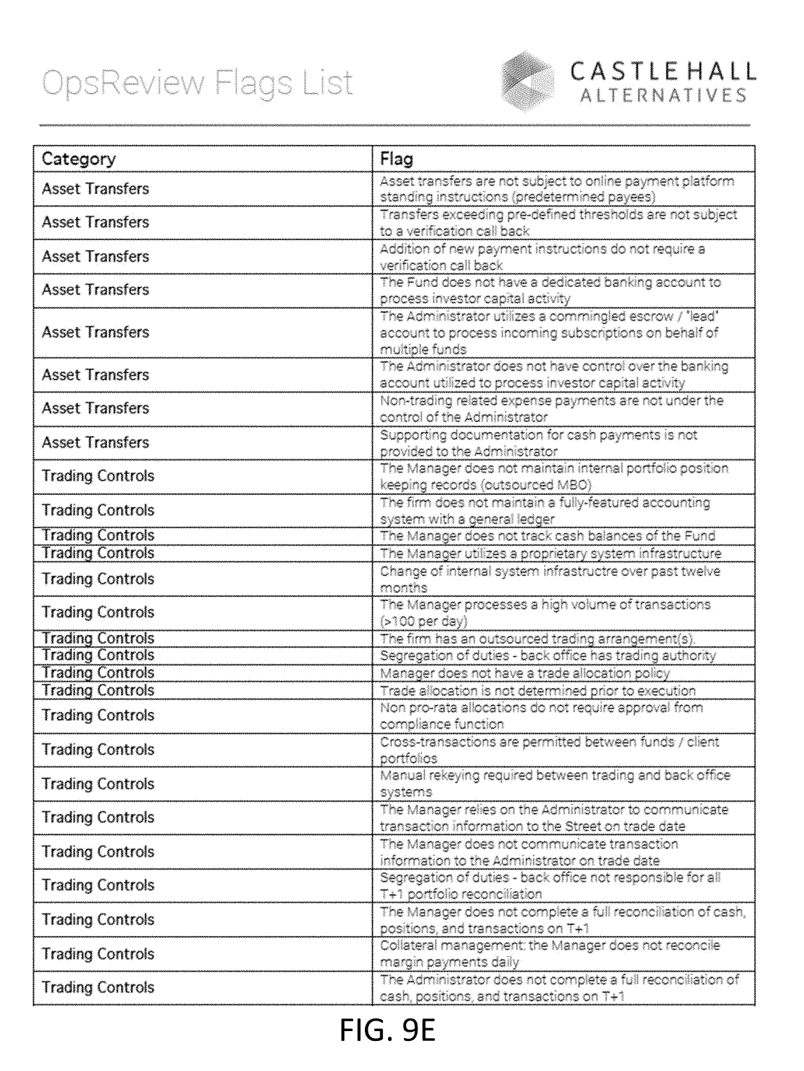

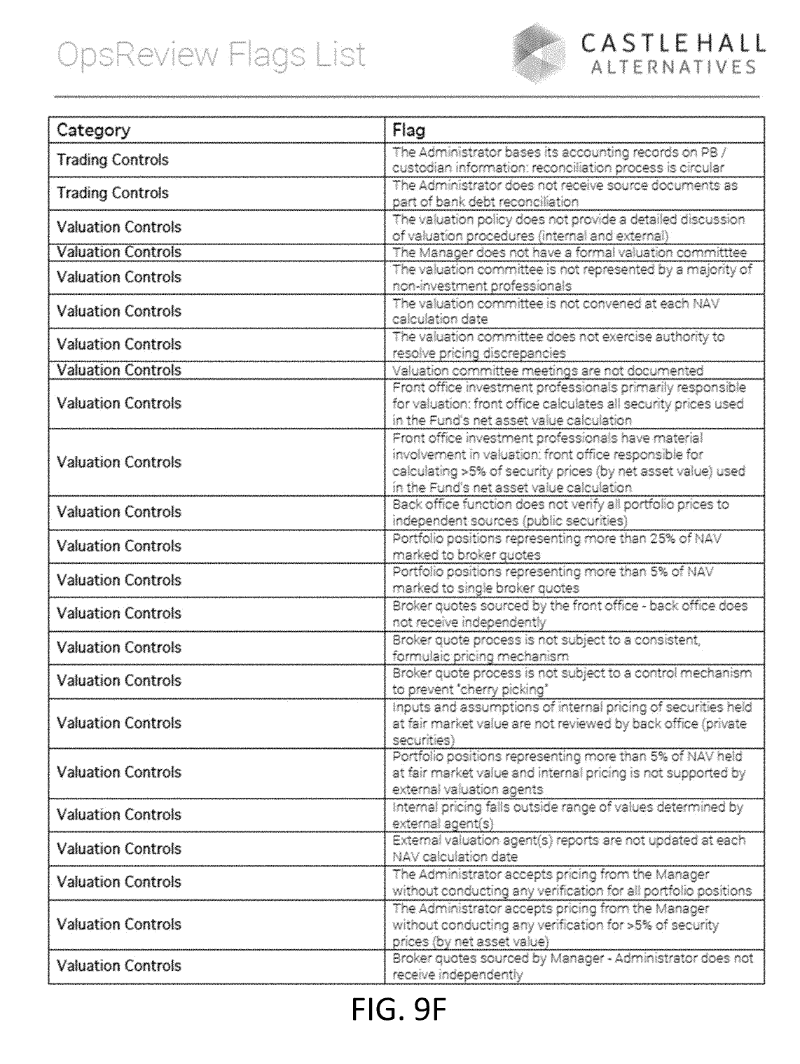

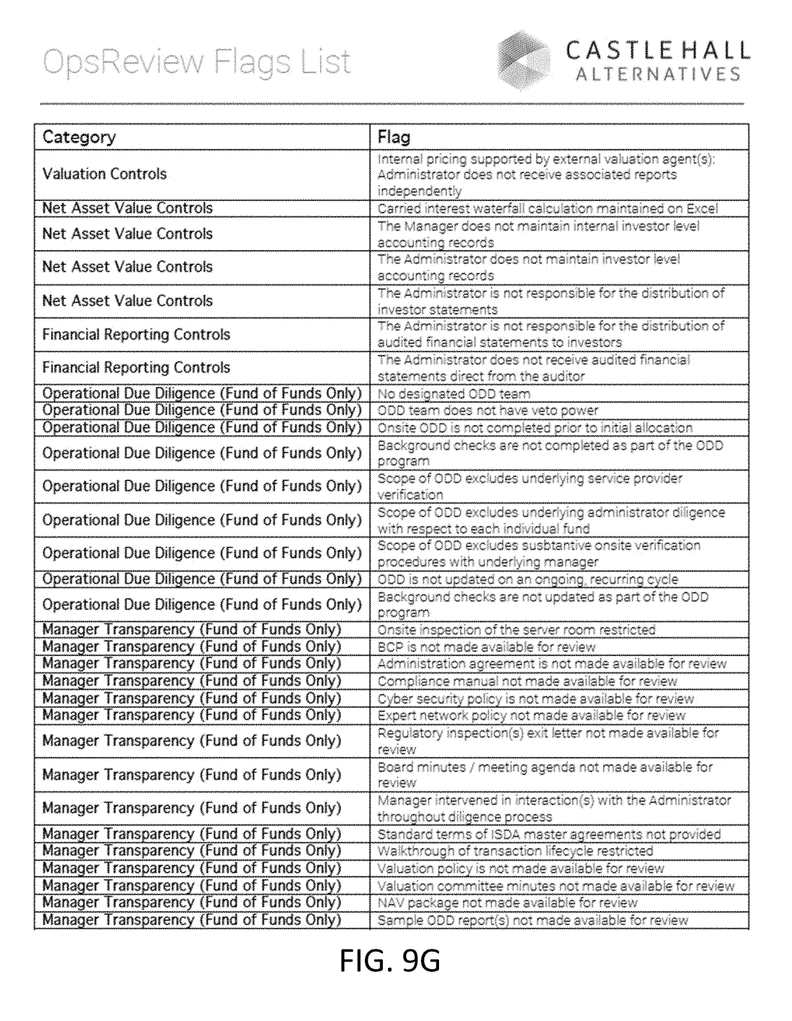

Referring to FIGS. 9A to 9G, there are shown examples of potential diligence related flags with associated flag categories.

At block 216, standardized text relating to each triggered diligence related flag is generated. Each diligence flag is pre-programmed with standard text describing the rationale behind the flag and the importance of the flagged issue from an operational diligence and risk perspective.

For example, the standardized text relating to the “Office space shared with unaffiliated third party” diligence flag:
Operator such as Castle Hall flags situations where a manager shares office space with an unaffiliated third party. The rationale for such arrangements should be considered (short term lease or permanent facility). Issues of physical security and data confidentiality may be material: is the manager's space physically secured (separate area of office or locked office(s)) or do some or all staff work in an unsecured or open plan are? Shared arrangements around IT facilities (e.g. server rooms) may also raise operational risk issues.

In another example, the standardized text relating to the “Firm is operating at or below breakeven AUM” diligence flag:
OpsReview procedures include specific discussion with each asset manager as to breakeven assets under management. Operator such as Castle Hall flags situations where current assets under manager are, per the management company, at or below breakeven levels. Dependent upon recent performance and/or marketing efforts and client pipeline, a manager with AUM below stated breakeven levels may indicate a material operational risk. Ability to continue as a going concern under such circumstances typically depends on the founding partner/key executives' ability to provide working capital to sustain the business.

Following this, at block 218, the iterative report review and finalization process is initiated. Once the components of the diligence process are completed the report is subjected to an iterative review process through senior diligence and management team members for final authorization to be released to the client. As part of the iterative process, reviewers will test the diligence results, conclusions and flags to confirm that data, diligence and verification flags and text are both accurate and presenting properly to the client.

Once sign-off is received from the iterative review process, the review report is stored into the reports database 36 and, at block 220, provided to the online client portal via the client interface 46c.

### Client Interface

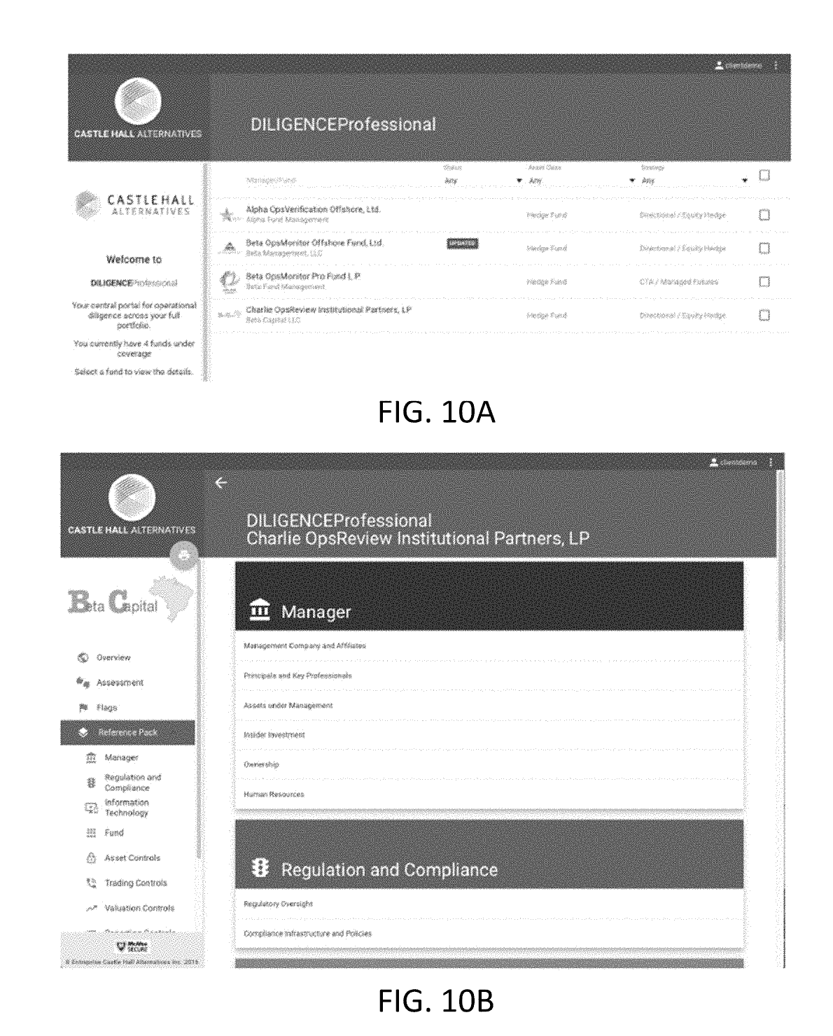

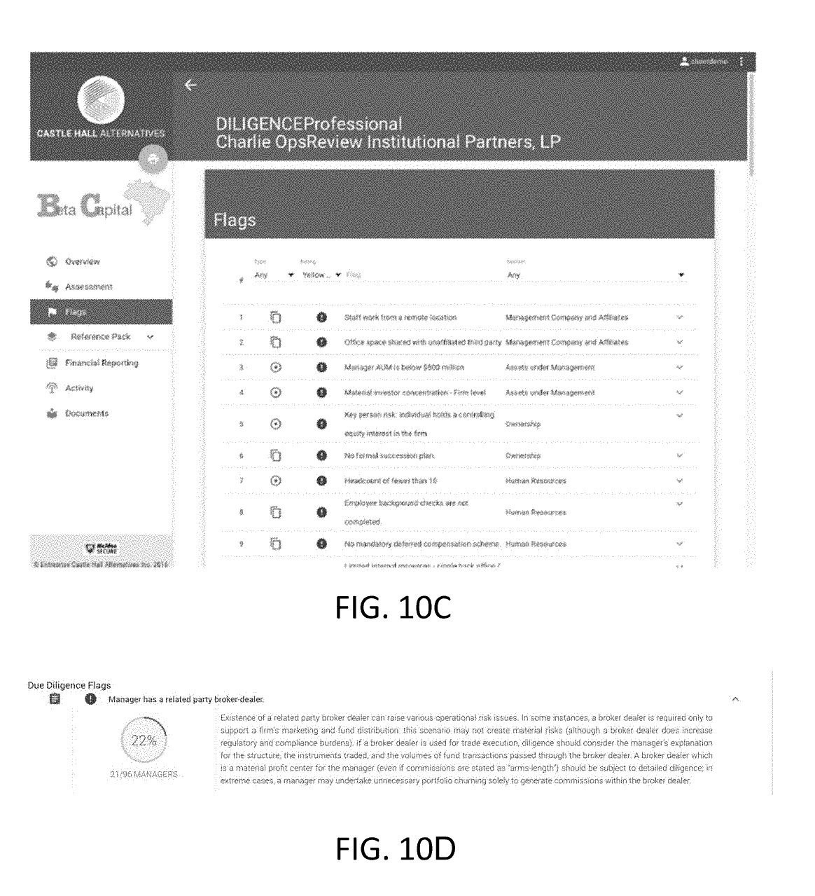

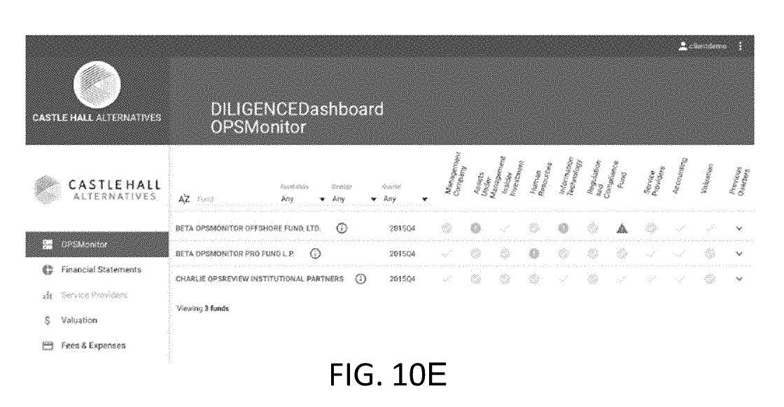

Referring to FIG. 10A to 10D, the client interface 46c, amongst other features, provides client with a navigation menu that allows clients to view available reports (stored in the reports database 36), indicating any updates, as well as, for a selected fund, access related reports, view related data (FIG. 10B), view related flags (FIG. 10C) and any documents received from the manager of the fund.

The client interface also presents aggregated risk factors derived from data and diligence flags across a client's portfolio (FIG. 10D). These risk factors will also be aggregated across the entire database (data & documents database 34), in order to facilitate industry peer group analysis.

Furthermore, the client interface 46c presents monitoring flags (FIG. 10E) in an efficient and effective way, which facilitates comparison of year-over-year or quarter-over-quarter observations.

Although the present disclosure has been described with a certain degree of particularity and by way of an illustrative embodiments and examples thereof, it is to be understood that the present disclosure is not limited to the features of the embodiments described and illustrated herein, but includes all variations and modifications within the scope and spirit of the disclosure as hereinafter claimed.

1. A method for providing an operational due diligence report for an investment, the method comprising the steps of:
identifying an asset class for the investment;
issuing a standardized due diligence questionnaire corresponding to the asset class, the questionnaire including data and service providers information;
receiving a response to the due diligence questionnaire;
verifying data and service providers information from the response to the standardized due diligence questionnaire, the verification of the service providers information including requesting further service provider information from the service providers identified in the service providers information;
triggering data and verification flags, each flag having a binary decision-making condition based on the data and service providers information, if the condition is met, the flag is triggered and if the condition is not met, the flag is not triggered;
generating standardized text relating to each of the triggered data and verification flags, the standard text describing the rationale behind an associated triggered flag and the importance of the issue related to the triggered flag from an operational data perspective;
generating a first version of the operational due diligence report for the investment, the operational due diligence report including a due diligence verification report; and
providing the first version of the operational due diligence report.

2. The method of claim 1, further comprising the step of:
issuing a guided-survey corresponding to the asset class, the questionnaire including a preliminary manager diligence part, an administrator diligence survey part and an onsite manager diligence survey part;
receiving a response to the guided-survey;
verifying preliminary manager diligence, administrator diligence and onsite manager diligence information from the response to the guided-survey;
triggering diligence flags, each flag having a binary decision-making condition based on the preliminary manager diligence, the administrator diligence and the onsite manager diligence information, if the condition is met, the flag is triggered and if the condition is not met, the flag is not triggered;
generating standardized text relating to each of the triggered preliminary manager diligence, administrator diligence and onsite manager diligence flags, the standard text describing the rationale behind an associated triggered flag and the importance of the issue related to the triggered flag from an operational diligence and risk perspective;
generating a second version of the operational due diligence report, the operational due diligence report including a due diligence review report;
initiating an iterative review of the due diligence review report;
generating an operational due diligence report for the investment; and
providing the second version of the operational due diligence report.

3. A system for performing an operational due diligence for an investment, the system comprising:
at least one database;
an input/output interface; and
a processor operatively connected to the at least one database and the input/output interface, the processor having an associated memory having stored therein processor executable code for causing the processor to:
execute the method of claim 1.

4. A system for performing an operational due diligence for an investment, the system comprising:
at least one database;
an input/output interface; and
a processor operatively connected to the at least one database and the input/output interface, the processor having an associated memory having stored therein processor executable code for causing the processor to:
execute the method of claim 2.
